(19) United States
(12) Patent Application Publication
(10) Pub. No.: US 2010/0133052 A1
(43) Pub. Date: Jun. 3, 2010

(54) Motor brake

(76) Inventor: Ta-Chuen Wei, Tali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,971

(22) Filed: Dec. 2, 2008

(51) Int. Cl. B60L 7/00

(52) U.S. Cl. 188/164

(57) ABSTRACT

A motor brake includes a locating plate affixed to a motor around the motor shaft, an outer panel connected to the locating plate with screws, a brake lining affixed to the locating plate, an inner panel movable along the screws between the brake lining and the outer panel, spring members connected between the inner panel and the outer panel for forcing the inner panel against the brake lining to stop the shaft of the motor from rotation, and two windings respectively mounted in the inner panel and the outer panel for attracting each other to move the inner panel away from the brake lining for allowing rotation of the motor shaft when electrically connected.

### BACKGROUND OF THE INVENTION

1. Field of the Invention

The present invention relates to a motor brake for motor and more particularly to such a motor brake, which is durable in use and, which accurately performs the braking action.

2. Description of the Related Art

FIGS. 1˜3 show a motor brake according to the prior art. According to this design, the motor brake comprises a locating plate 10 affixed to one side of a motor 18, an inner panel 11 mounted on one side of the locating plate 10 around the shaft 19 of the motor 18, a winding 13 mounted in an annular groove 12 in the inner panel 11, an outer panel 17 connected to the inner panel 11 with screws 41, a brake panel 14 movable along the screws 41 between the inner panel 11 and the outer panel 17, a brake lining 16 mounted on the shaft 19 of the motor 18 between the brake panel 14 and the outer panel 17, and spring members 15 supported between the inner panel 11 and the brake panel 14. When the winding 13 is electrically connected to produce a magnetic attractive force, the brake panel 14 is attracted by the magnetic attractive force and moved away from the brake lining 16, allowing rotation of the shaft 19 of the motor 18. This design of motor brake is still not satisfactory in function due to the following drawbacks:

1. Only one single winding 13 is provided to produce a magnetic attractive force for attracting the brake lining 16, the reaction speed in controlling rotation or stoppage of the shaft 19 of the motor 18 is low, and a braking error may occur.

2. Because of low magnetic attractive force, the spring force of the spring members 15 is limited, thus the force applied to the brake panel 14 against the brake lining 16 is limited, and the shaft 19 of the motor 18 may be not stopped accurately when braking.

3. During a braking action, the outer panel 17 receives a great torsional force from the braking lining 16, and therefore the screws 41 wear quickly with use.

### SUMMARY OF THE INVENTION

The present invention has been accomplished under the circumstances in view. It is therefore the main object of the present invention to provide motor brake, which has a rapid reaction speed to control rotation and stoppage of the motor accurately. It is another object of the present invention to provide a motor brake, which is durable in use, avoiding damage to the parts upon a braking action.

To achieve these and other objects of the present invention, a motor brake comprises a locating plate affixed to one side of a motor around a shaft of the motor; an outer panel connected to the locating plate with screws, the outer panel comprising an annular groove on one side thereof around the shaft of the motor; a brake lining affixed to one side of the locating plate around the shaft of the motor; an inner panel movable along the screws between the brake lining and the outer panel, the inner panel comprising an annular groove on one side thereof around the shaft of the motor and facing the annular groove of the outer panel; a plurality of spring members connected between the inner panel and the outer panel and adapted to force the inner panel against the brake lining in stopping the shaft of the motor from rotation; a first winding mounted in the annular groove of the inner panel and adapted to produce a magnetic attractive force for moving the inner panel away from the brake lining toward the outer panel when electrically connected; and a second winding mounted in the annular groove of the outer panel and adapted to produce a magnetic attractive force for attracting the first winding when electrically connected.

### BRIEF DESCRIPTION OF THE DRAWINGS

FIG. 1 is an exploded view of a motor brake according to the prior art.

FIG. 2 is sectional assembly view of the motor brake according to the prior art.

FIG. 3 corresponds to FIG. 2, showing a braking status of the motor brake.

FIG. 4 is an exploded view of a motor brake according to the present invention.

FIG. 5 is sectional assembly view of the motor brake according to the present invention.

FIG. 6 corresponds to FIG. 5, showing a braking status of the motor brake.

FIG. 7 is a schematic side view of the present invention, showing the locating blocks of the outer panel respectively disengaged from the locating notches of the inner panel.

FIG. 8 corresponds to FIG. 7, showing the locating blocks of the outer panel respectively engaged with the locating notches of the inner panel.

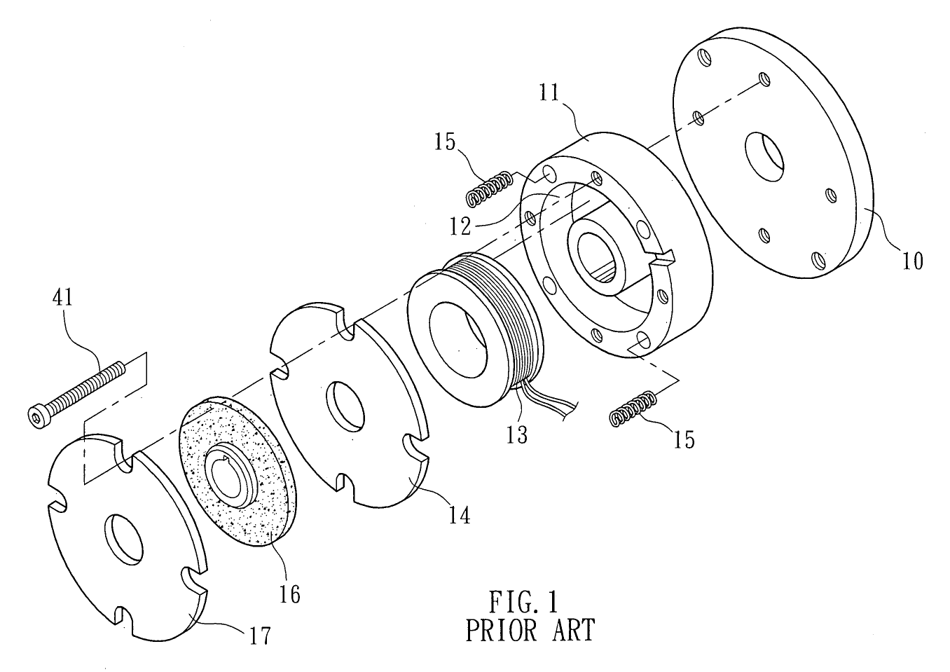

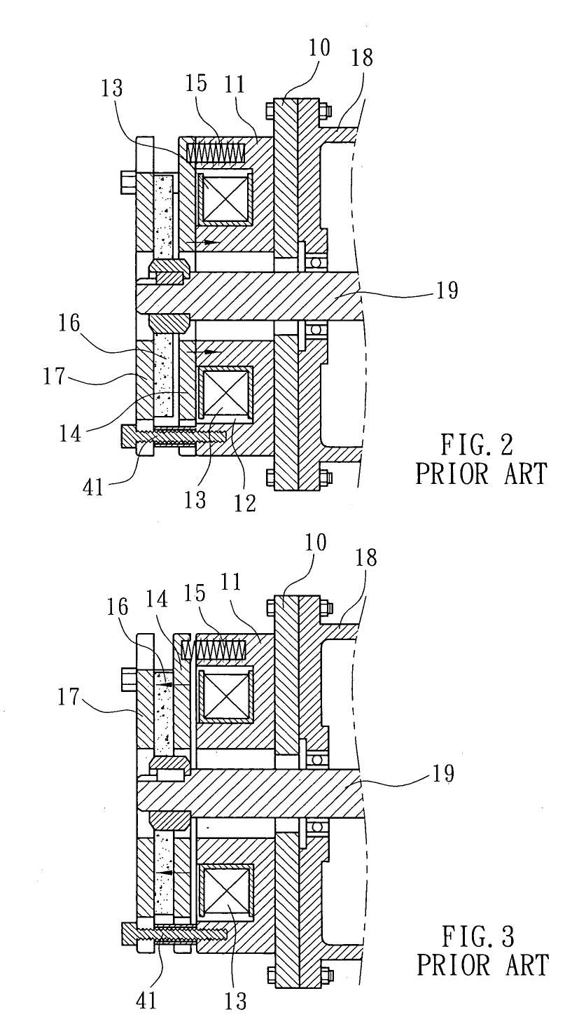

### DETAILED DESCRIPTION OF THE PREFERRED EMBODIMENT

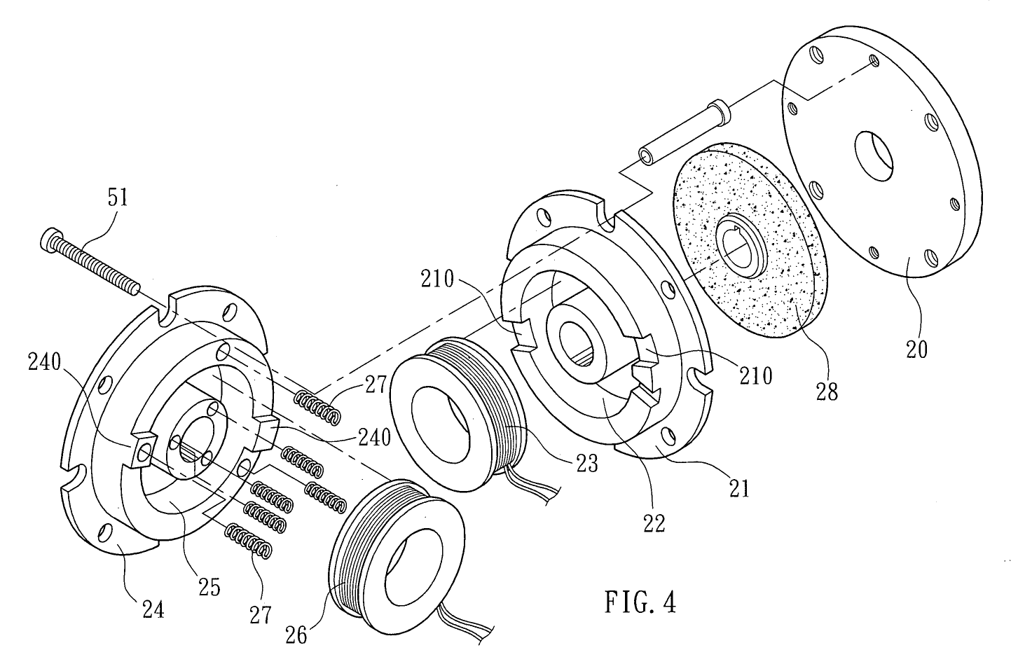

Referring to FIGS. 4˜6, a motor brake in accordance with the present invention is shown comprising a locating plate 20 affixed to one side of a motor 30 around a shaft 31 of the motor 30, an outer panel 24 connected to the locating plate 20 with screws 51, a brake lining 28 affixed to one side of the locating plate 30 around the shaft 31 of the motor 30, an inner panel 21 movable along the screws 51 between the brake lining 28 and the outer panel 24, a plurality of spring members 27 connected between the inner panel 21 and the outer panel 24 to force the inner panel 21 against the brake lining 28, a first winding 23 mounted in an annular groove 22 in one side of the inner panel 21 and facing the outer panel 24, and a second winding 26 mounted in an annular groove 25 in one side of the outer panel 24 and facing the first winding 23. Further, the inner panel 21 has two locating notches 210 on its one side. The outer panel 24 has two locating blocks 240 for engaging into the locating notches 210 of the inner panel 21.

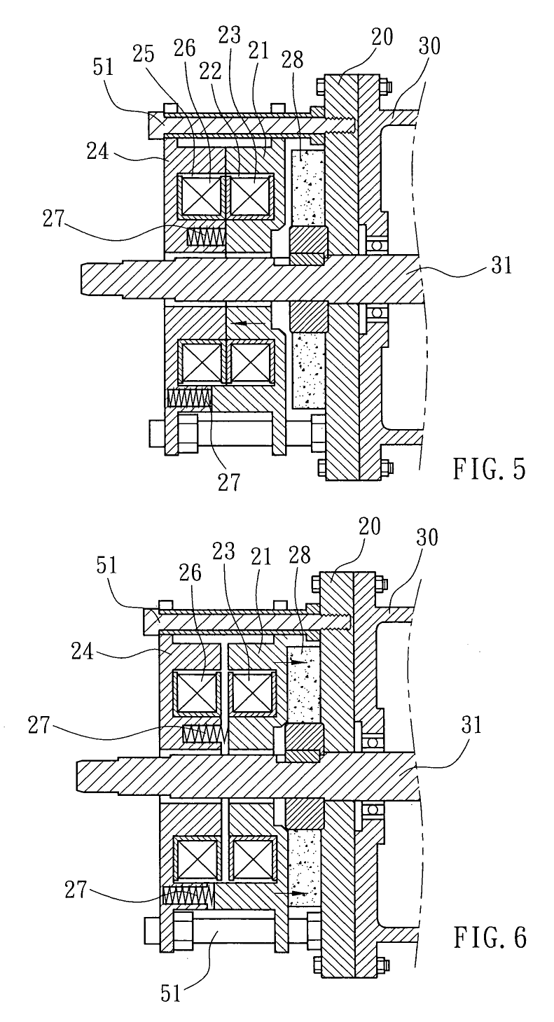

When the first winding 23 and the second winding 26 are electrically connected, they attract each other, holding the inner panel 21 away from the brake lining 28 for free rotation of the shaft 31 of the motor 30 (see FIG. 5).

When electricity is cut off from the first winding 23 and the second winding 26, the spring members 27 immediately forces the inner panel 21 against the brake lining 28, stopping the shaft 31 of the motor 30 from rotation.

As stated above, the invention has the following effects:

1. The first winding 23 and the second winding 26 attract each other when electrically connected, moving the inner panel 21 away from the brake lining 28 rapidly and accurately. Therefore, this double-winding design enhances control accuracy.

2. The double-winding design doubles the magnetic attractive force, therefore a relatively greater number of spring members 27 can be installed to support the inner panel 21 and to force the inner panel 21 toward the locating plate 20 against the brake lining 28 when electricity is cut off from the first winding 23 and the second winding 26.

3. In case one winding 23 or 26 fails, the other winding 26 or 23 can still function well to attract the inner lining 21, moving the inner panel 21 away from the brake lining 28.

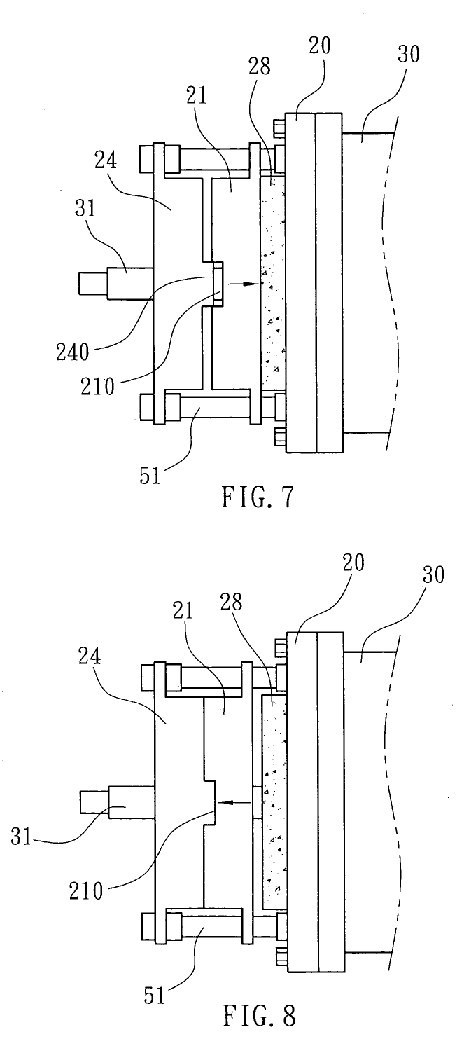

Referring to FIGS. 7 and 8, the locating blocks 240 of the outer panel 24 are respectively coupled to the locating notches 210 of the inner panel 21. When the inner panel 21 is moved away from the brake lining 28 and the brake lining 28 is rotated with the locating plate 20 and the shaft 31 of the motor 30, as shown in FIG. 8, the locating blocks 240 of the outer panel 24 are respectively positively engaged with the locating notches 210 of the inner panel 21, avoiding vibration of the inner panel 21 and accurate attraction between the first winding 23 and the second winding 26. When braking the shaft 31 of the motor 30, as shown in FIG. 7, the locating blocks 240 and the locating notches 210 receive torsional force from the brake lining 28, avoiding damage to the screws 51.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A motor brake, comprising
a locating plate affixed to one side of a motor around a shaft of said motor;
an outer panel connected to said locating plate with screws, said outer panel comprising an annular groove on one side thereof around said shaft of said motor;
a brake lining affixed to one side of said locating plate around said shaft of said motor;
an inner panel movable along the screws between said brake lining and said outer panel, said inner panel comprising an annular groove on one side thereof around said shaft of said motor and facing the annular groove of said outer panel;
a plurality of spring members connected between said inner panel and said outer panel and adapted to force said inner panel against said brake lining in stopping said shaft of said motor from rotation;
a first winding mounted in the annular groove of said inner panel and adapted to produce a magnetic attractive force for moving said inner panel away from said brake lining toward said outer panel when electrically connected; and
a second winding mounted in the annular groove of said outer panel and adapted to produce a magnetic attractive force for attracting said first winding when electrically connected.

2. The motor brake as claimed in claim 1, wherein said inner panel comprises a plurality of locating notches equiangularly spaced around the annular groove thereof; said outer panel comprises a plurality of locating blocks equiangularly spaced around the annular groove thereof for engaging into the locating notches of said inner panel.
